(19) United States
(12) Patent Application Publication
(10) Pub. No.: US 2006/0073843 A1
(43) Pub. Date: Apr. 6, 2006

(54) Content formatting and device configuration in group communication sessions

(76) Inventors: Naveen Aerrabotu, Gurnee, IL (US); Lawrence A. Willis, McHenry, IL (US); Greg R. Black, Vernon Hills, IL (US); Charles P. Binzel, Bristol, WI (US); Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/956,281

(22) Filed: Oct. 1, 2004

(51) Int. Cl. H04Q 7/20

(52) U.S. Cl. 455/519; 455/518

(57) ABSTRACT

A method in a communication network entity, for example, a push-to-talk/anything server, for content sharing in a group communication session including obtaining (210) participant information from a plurality of group participants, determining (220) common group information based on the group participant information obtained, and sending (230) the common group information to the group participants, wherein the group participants format content based on the common group information before communicating content to other participants of the group session.

### FIELD OF THE DISCLOSURE

The present disclosure relates generally to group communications among two or more communication devices, and more particularly to device configuration and content formatting for transfer to group communication session participants, for example, in push-to-transfer sessions over push-to-talk wireless communication networks, features and methods.

### BACKGROUND

Group communication sessions including push-to-talk (PTT) and push-to-anything (PTX) sessions among predefined groups of mobile subscriber terminals in cellular communication networks are known generally. PTX represents a broader “Push To . . . ” experience beyond voice, although performed in the same manner of a “PTT” session and using an extension of PTT infrastructure. PTX includes a collection of data types that can be pushed to one person or a group of people or among session participants in real-time. The concept of “Push” implies the immediacy of a substantially “real time transfer.” This is in contrast to more traditional SMS or MMS messaging, which is more “store and forward.” PTX implies urgency and/or immediacy of data transfer. In PTT/PTX systems, information, for example, speech, images, sounds, files, locations, text, video, etc. is often transferred in real-time upon the “press” of a share button. PTX is data type and size agnostic. A receipt-acknowledge subsystem may also be employed to convey a guarantee to the sender that the information has been received correctly by intended recipients. Transfer progress on receiving and sending screens may also be provided. The support of user group lists and addressing, presence, and buddy list applications are also possible. PTX also supports streaming of information. In this way, the receiving user does not have to wait to receive the entire content before playback or viewing.

In the most commonly known cellular network push-to-talk or push-to . . . sessions, group participants communicate in half-duplex mode. When one group participant talks or transfers data, the other group participants may only listen or receive until the talking or transferring participant, sometimes referred to as the floor holder, relinquishes the floor or upon expiration of a specified time period.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary PTT/PTX over cellular (PoC) communication architecture.

FIG. 2 illustrates an exemplary process flow diagram.

FIG. 3 illustrates an exemplary process flow diagram.

FIG. 4 illustrates an exemplary PTT/PTX process flow diagram.

FIG. 5 illustrates another exemplary process flow diagram.

### DETAILED DESCRIPTION

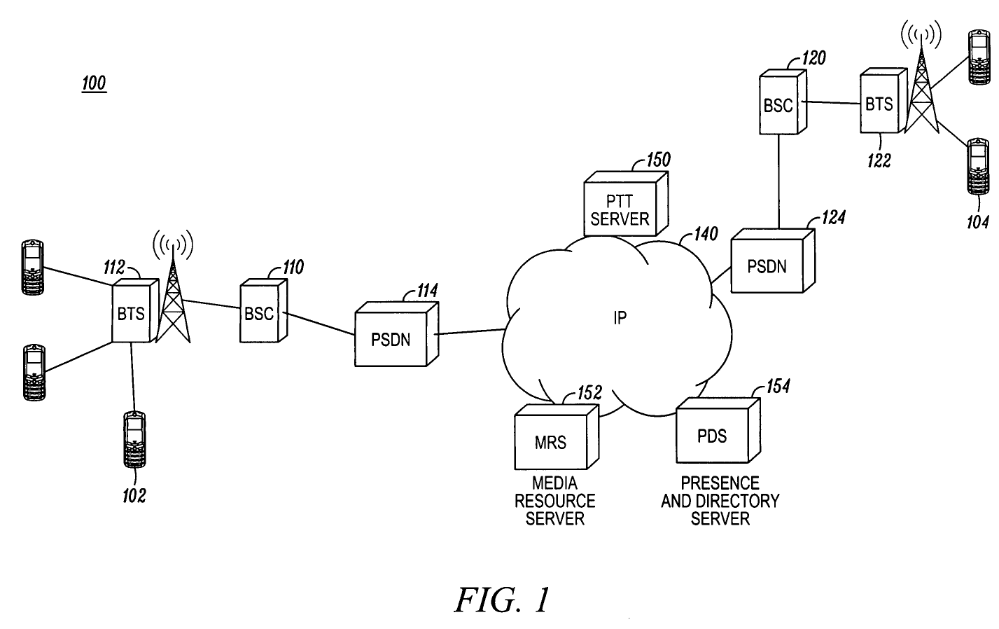

FIG. 1 is an exemplary push/press-to-talk (PTT)/push-to-anything (PTX) over cellular (PoC) communication architecture 100 comprising generally multiple base station controllers BSC 110 and BSC 120 each of which is communicably coupled to a corresponding plurality of base transceiver stations exemplified by BTS 112 and BTS 122, respectively. The base station controllers BSC 112 and BSC 120 are both communicably coupled to corresponding packet data serving nodes PDSN 114 and PDSN 124, respectively. In FIG. 1, each BSC is communicably coupled to a network, for example, to an IP network 140 like the Internet, by a corresponding PDSN. In FIG. 1, the PDSNs are both communicably coupled to a PTT server 150 via the network 140. The PDSN 114 and PDSN 124 are also communicably coupled to a media resource server MRS 152 and to a presence and directory server PDS 154.

In one embodiment, the network is a cellular communication network, for example, a GSM and/or W-CDMA based 2.5/3^{rd} Generation 3GPP network or a 3GPP2 CDMA communication network, among other existing and future generation communication networks. In these and other cellular communication network implementations, the base station controllers, for example, BSC 110 and BSC 120 in FIG. 1, are communicably coupled to a mobile switching station (MSC) that is communicably coupled to a public switched telephone network (PSTN). An MSC and a PSTN are not illustrated in the exemplary architecture of FIG. 1 although these entities and the functionality thereof are well known by those having ordinary skill in the art.

FIG. 1 also illustrates terminals, for example, mobile stations 102 and 104, capable of communicating with one another over the exemplary PTT/PTX network. Contemporary PTT/PTX implementations over cellular communication networks use IP packet data techniques. In particular, packet data protocols are utilized conforming to formats and protocols defined by industry organizations such as the IETF and W3C, which include IP, TCP, UDP, and among other protocols. Other standards bodies define how the packet data information is utilized in conjunction with wireless networks include 3GPP, 3GPP2, the IEEE, etc. In other embodiments, the PTT/PTX functionality may be implemented over some other type of network. In the exemplary PTT/PTX architecture, the wireless communication devices, for example, terminals 102 and 104 in FIG. 1, operate in a one-half duplex mode during the group communication session. In other embodiments, however, the terminals communicate over the PTT/PTX network in full duplex mode.

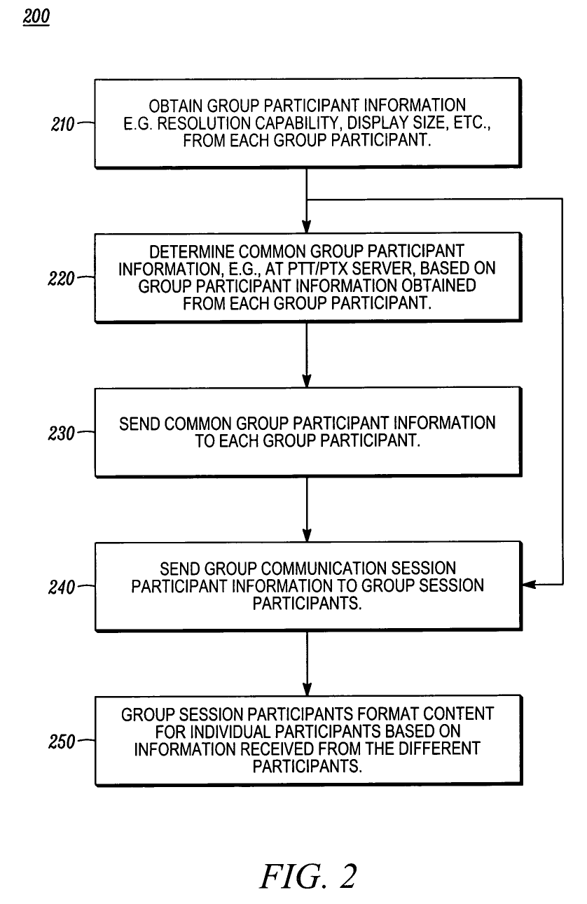

In one embodiment, illustrated in the process diagram of FIG. 2 at block 210, a network entity, for example, the PTT/PTX server 150 in FIG. 1, obtains group participant information from each group session participant. In one embodiment, the group participant information is content expression capability including, for example, video display resolution capability information, and/or display size capability information, and/or frame rate encoding/decoding capacity information, and/or audio fidelity information, and/or encoding format information, and/or some other content expression and/or processing or acquisition capability information. This and other information is generally obtained and/or updated by the network entity when group communication session participants attach to the network and/or when the participants attach to the group. Other information that may be obtained and/or maintained by the server includes but is not limited to recipient names, mobile IDs, phone numbers etc. This information may be obtained for all group members, whether or not they are participants in a particular group session.

In FIG. 2, at block 220, “common group information” is determined based on the entire collection of “participant information” for each group participant obtained or received by the PTT/PTX entity. In one embodiment, the common information is determined based only on the participants in a current or developing group session. The determination of the “common group information” can be based on any methodology including the least or greatest common denominator for the collection of “participant information”, examples of which are discussed further below.

In FIG. 2, at block 230, in embodiments where the common group information is determined in or at the PTT/PTX server, the network communicates or otherwise conveys the “common group information” to each group participant. The group participants then use the “common group information” to determine how to code and send content to the other participants in the group session. In one embodiment, for example, the common group information is common configuration information used by the participants to configure a camera engine on the terminal.

In another embodiment, the individual participant information is conveyed from each participant through the server to all other participants. The participant information may be obtained from each of the respective group participants by the information being pushed from the originating participant or upon querying each participant in a negotiation protocol. Then, each subscriber determines, based on a common algorithm, the common group information with based on the participant information from all of the participants or at least the other participants. In an alternative embodiment, a subscriber obtains the participant information for each group participant from the PTT/X server. However, the participants need not convey this information to the server. Rather, the PTT/X server has a data base of all the group participants so that it may provide proper packet forwarding of information from one user to all the others. The database in the PTT/X server has device information for each participant. Parametric descriptions for each possible member of a group can be populated manually by the system operator. This is slightly different from each user in the group conveying information from itself to the server data base automatically upon registration or sign-on of the user with the server.

In one embodiment, the common group information may be obtained as part of a negotiation based on the group participant information and/or other criteria used by the entity determining the common group information, for example, the PTT/X server 150 in FIG. 1. Generally, if there is a change in the make-up of the group communication session participants, the common group information may be changed or re-negotiated based on the change in the group participant information. In one embodiment, for example, common group image resolution information is determined, based on individual group participant resolution capability information, such that all group communication session participants are capable of utilizing content at the resolution group selected. If a new participant having a lower resolution capability joins the group, it may be desirable to reduce the common group content resolution to enable the new participant to view the content. Similarly, if the participant with the lowest resolution capability exits from the group session, it may be desirable to increase the common group content resolution accordingly.

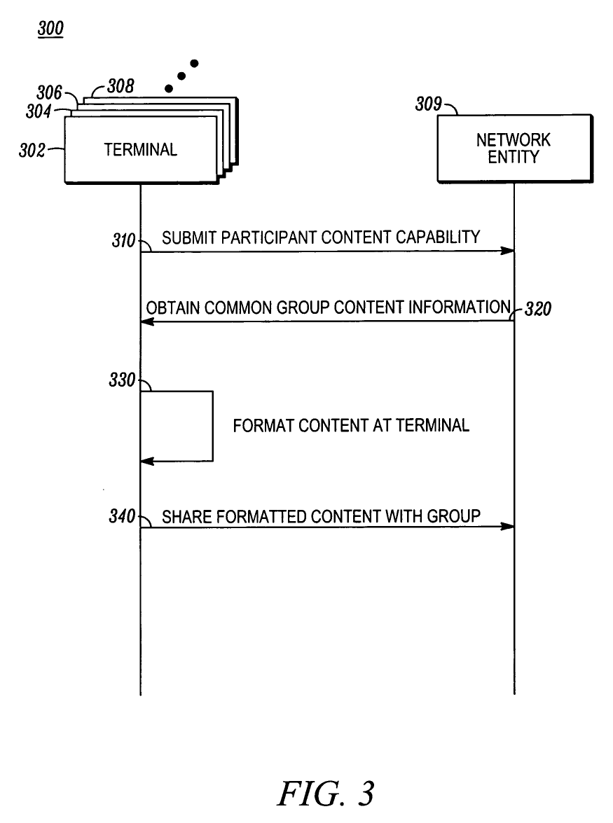

In the exemplary process flow diagram 300 of FIG. 3, at 310, terminals 302, 304, 306, 306 . . . in a group communication session each submit participant content capability information, for example, display size, to a network entity 309, for example, a PTT/PTX server. In some embodiments, it is not necessary for the terminals to submit the same information to the network entity every time the terminal connects to the network or the group. This information may have been obtained previously and stored previously at the network, for example, during a prior group session or during the initial service subscription setup. After the initial participant information submission, for example, it may only be necessary for the terminal to provide updated participant information. At 320, the terminals obtain common group content information, for example, common display size information as determined at the network entity as discussed above. At 330, the terminals format content, for example, resize pictures, at the terminal, based on the common group display size information obtained from the server at 320. At 340, the terminals send the formatted content, for example, the resized picture, to the other group session participants via the PTT/X server using the PTT/X functionality.

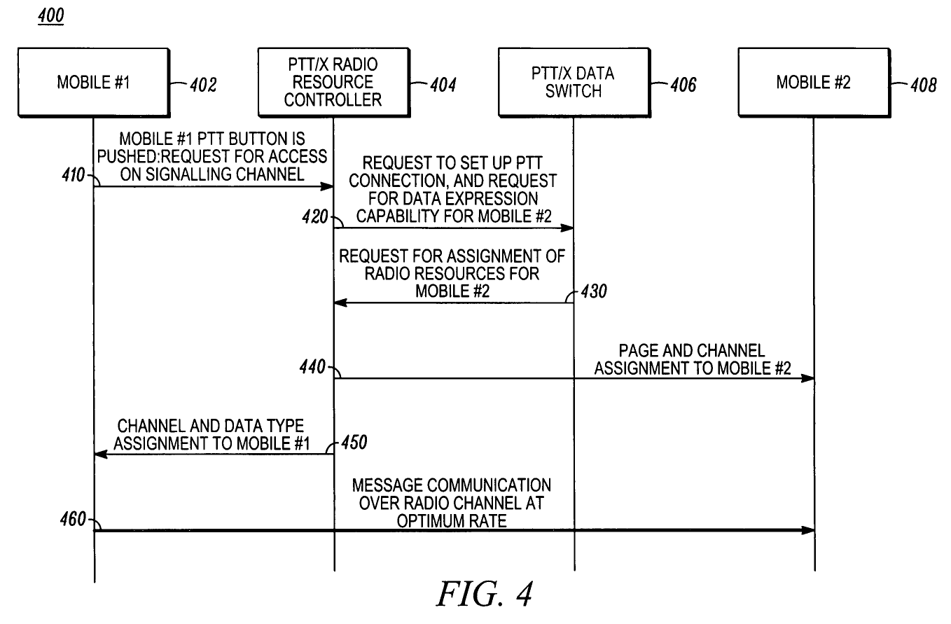

The process 400 in FIG. 4 is more specific to a push-to-talk (PTT)/push-to-anything (PTX) communication between mobile terminals in a cellular communications network environment. In the exemplary PTT/PTX application, the terminals operate in a one-half duplex mode, though the disclosure also encompasses applications and embodiments where the terminals operate in full duplex mode. At 410, a first mobile terminal 402 in FIG. 4, requests access on a signaling channel from a PTT/X radio resource controller 404, for example, by depressing a PTT/X button on the first terminal 402. At 420, the PTT/X radio resource controller 404 communicates a setup PTT/X connection request to a PTT/X data switch 406. The PTT/X radio resource controller 404 also requests the content capability information, for example, the data expression capability, for a second mobile terminal 408 in FIG. 4. At 430, the PTT/X data switch 406 communicates a radio resource assignment request for the second terminal to the PTT/X radio resource controller 404. At 440, the PTT/X radio resource controller 404 communicates a page and the channel assignment to the second mobile terminal 408. At 450, the channel assignment and common group content information are communicated from the PTT/X radio resource controller 404 to the first mobile terminal 402, which configures or formats content based on the common group content information. At 460, the first mobile terminal 402 communicates over the assigned radio channel at some optimal rate based on the common group content information.

In group communication systems such as group PTT/X systems, the group participants may have varying ability to express data. Participants with capability for richer expression of data, for instance, those with higher fidelity audio capability or higher resolution video capability require more message data than participants with a lower capability. Thus group members with higher ability need more data and decode at higher data rates, and members with lower capability need less data and decode at lower rates. In the alternative embodiment of FIG. 2, at block 240, the network entity sends the group communication session participant information to the group communication session participants. Alternatively, the group participants may share this information directly. At block 250, each group participant uniquely formats content for each of the participants to which the content will be sent based on the content capability information received from the participants at block 240.

In another exemplary embodiment, formats that may be decoded at varying rates are used in digital video broadcasting (DVB). Similarly many existing audio and video file formats (MP3, MPEG, etc) may be decoded according to recipient group member capability. Variable rate decoding formats accommodate recipients with varying ability to express the data. In a particular embodiment, the sender encodes content with an amount of data sufficient for the recipient with the highest data expression capability. This assumes that the recipients with lower data expression capability are able to employ the higher rate data in the lower expression capability, or decode the data at a lower rate. The advantage of this strategy is that, in the event that a maximum data expression capability recipient is not in the group, the sender will encode the message with less than the maximum data content, thereby saving network capacity and mobile station resources.

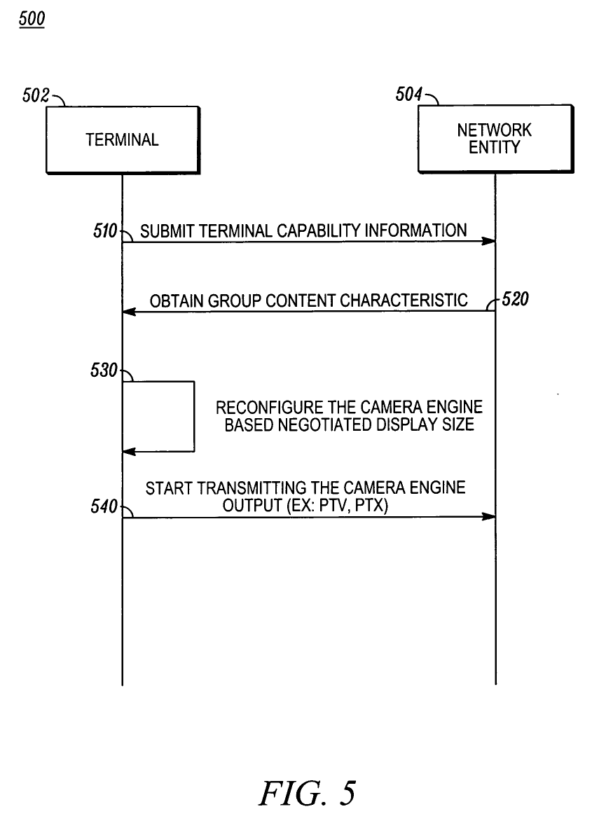

In the exemplary process flow diagram 500 of FIG. 5, at 510, a terminal 502 in a group communication session submits participant terminal capability information, for example, display size, to a network entity 504, for example, a PTT/X server. In some embodiments, this information may have been provided to the network entity 504 at some prior time or by another entity, for example, the service provider may obtain this information at the time of subscription activation. At 520, the terminal 502 obtains common group information, for example, a common group display size or other common accessory configuration information from the network entity 504. At 530, the terminal configures an accessory, for example, a still or video camera engine, on the terminal based on the common group information obtained from the network entity. At 540, the mobile transmits the accessory output, for example, the camera engine output, to the group session participants using the PTT/X functionality. In other embodiments, other accessories and applications of the terminal may also be configured or re-configured based on the common group information.

The process of FIG. 5 may be generalized to include negotiating with some other entity outside the context of a group communication session, and configuring the accessory of the fixed-base or mobile wireless terminal based on the negotiation. For example, the terminal may obtain accessory configuration information from a network entity upon registering or otherwise attaching to the network. Alternatively, the terminal may obtain the accessory configuration information directly from another terminal upon negotiating with the other terminal. In some embodiments, the terminal may be in a group communication session, though in other embodiments the terminal is not necessarily in a group communication session.

While the present disclosure and what are presently considered to be the best modes thereof have been described in a manner that establishes possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device in a group communication session, the method comprising:
obtaining a common group content information for group communication session participants;
formatting content, at the wireless communication device, based on the common group content information obtained.

2. The method of claim 1, operating the wireless communication device in a one-half duplex mode during the group communication session.

3. The method of claim 1, obtaining the common group content information for the group communication session participants by negotiating with the group communication session participants via a network server.

4. The method of claim 3, re-negotiating the common group content information with other group communication session participants if there is a change in group communication session participants.

5. The method of claim 3, negotiating the common group content information with the other group communication session participants includes negotiating a common group content resolution with the group communication session participants via a network server.

6. The method of claim 1,
configuring a camera engine on the wireless communication device based on the common group content information obtained,
generating camera-based content at the wireless communication device after configuring the camera engine,
formatting the camera-based content based on the common group content information obtained.

7. The method of claim 1,
obtaining the group content characteristic includes obtaining a content encoding format for the group communication session participants;
formatting content includes encoding content based on the content encoding format obtained.

8. The method of claim 1,
obtaining the common group content information includes determining the common group content information at the wireless communication device based on group participant information obtained from a group communication session server.

9. The method of claim 1,
obtaining the common group content information for the group communication session participants from a group communication session server.

10. A method in a wireless communication device, the method comprising:
obtaining content capability information for another communication terminal;
configuring a camera engine on the wireless communication device based on the content capability information.

11. The method of claim 10,
generating camera-based content at the wireless communication device after configuring the camera engine,
formatting the camera-based content based on the content capability information obtained.

12. The method of claim 10, obtaining the content capability information includes obtaining common content resolution information based on content resolution capability information from individual participants in a group communication session.

13. The method of claim 12, obtaining the common content resolution information includes obtaining one of common still image display size information and common video image data rate information.

14. A method in a communication network entity for content sharing in a group communication session, the method comprising:
obtaining participant information, from a plurality of group communication session participants, at the communication network entity;
determining common group information based on the group communication session participant information obtained;
sending the common group information to at least one group communication session participant.

15. The method of claim 14,
sending the common group information to all group communication session participants from which participant information was received.

16. The method of claim 14,
determining the common group information includes selecting a common group content resolution capable of being displayed by all group communication session participants.

17. The method of claim 14,
determining the common group information includes selecting a common group content resolution capable of being displayed by a group communication session participant having a lowest content expression capability.

18. The method of claim 14,
determining the common group information includes determining one of common still image display size and common video image data rate.

19. A method in a wireless communication device, the method comprising:
negotiating with another entity;
configuring an accessory of the wireless communication device based on the negotiation with another entity.

20. The method of claim 19, configuring the accessory of the wireless communication device includes configuring a camera based on the negotiation with another entity.

21. The method of claim 19, operating the wireless communication device in a group communication session while negotiating.

22. The method of claim 21, operating the wireless communication device in a one-half duplex mode during the group communication session.

23. A method in a wireless communication terminal in a group communication session, the method comprising:
obtaining capability information for each of several other group communication session participants;
uniquely formatting content for each of several other group communication session participants based on the corresponding capability information obtained from each of the other group communication session participants;
sending the uniquely formatted content to each of the other group communication session participants.

24. The method of claim 23, obtaining the capability information for each of several other group communication session participants from a push-to-talk server upon attaching to the group communication session.
